(19) United States
(12) Patent Application Publication
(10) Pub. No.: US 2025/0246079 A1
(43) Pub. Date: Jul. 31, 2025

(54) VEHICLE MONITORING SYSTEM AND METHOD

(71) Applicant: Ford Global Technologies, LLC, Dearborn, MI (US)

(72) Inventors: Stuart C. Salter, White Lake, MI (US); Brendan Diamond, Grosse Pointe, MI (US); Kendra White, Ann Arbor, MI (US); Keith Weston, Canton, MI (US); John Robert Van Wiemeersch, Novi, MI (US)

(73) Assignee: Ford Global Technologies, LLC, Dearborn, MI (US)

(21) Appl. No.: 18/425,950

(22) Filed: Jan. 29, 2024

(51) Int. Cl. G08G 1/00; G08G 1/0968; H04W 4/44

(52) U.S. Cl. CPC G08G 1/205; G08G 1/0968; H04W 4/44

(57) ABSTRACT

A first vehicle including a transceiver and a processor is disclosed. The transceiver may be configured to transmit a surveillance request to a first set of vehicles and/or a first set infrastructure sensors located within a first radius from the first vehicle, and receive inputs from a second vehicle from the first set of vehicles and/or a first infrastructure sensor from the first set of infrastructure sensors responsive to transmitting the surveillance request. The processor may be configured to determine that a predefined condition may be met based on the inputs. The processor may further cause the transceiver to transmit the surveillance request to a second set of vehicles and/or a second set of infrastructure sensors located within a second radius from the first vehicle, responsive to determining that the predefined condition may be met. The second radius may be greater than the first radius.

### FIELD

The present disclosure relates to a vehicle monitoring system and method for a parked vehicle.

### BACKGROUND

There are known instances of parked vehicles encountering adverse situations. For example, a vehicle or an object may inadvertently contact a parked vehicle, which may affect the parked vehicle's performance and/or appearance and cause inconvenience to the parked vehicle's owner. In such situations, the parked vehicle's owner typically attempts to identify an identity of the vehicle that contacted the parked vehicle, the reasons that may have led to the contact, and/or the like. Currently, there are limited means that may assist the parked vehicle's owner to identify such information.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example environment in which techniques and structures for providing the systems and methods disclosed herein may be implemented.

FIG. 2 depicts a block diagram of an example vehicle monitoring system in accordance with the present disclosure.

FIG. 3 depicts example parking spot recommendations being displayed on a vehicle Human-Machine Interface (HMI) in accordance with the present disclosure.

FIG. 4 depicts a top view of a parked vehicle transmitting surveillance requests to a plurality of vehicles in a parking lot in accordance with the present disclosure.

FIG. 5 depicts an example snapshot of an adverse situation being encountered by a parked vehicle in accordance with the present disclosure.

FIG. 6 depicts a flow diagram of an example vehicle monitoring method in accordance with the present disclosure.

### DETAILED DESCRIPTION

### Overview

The present disclosure describes a system and method for enabling monitoring of a vehicle (or a “first vehicle”) from all vehicle sides/angles when the first vehicle may be parked in a parking lot. The vehicle monitoring from 360 degree angles may be performed by using images/videos captured by additional vehicles that may be parked in proximity to the first vehicle and/or infrastructure sensors that may be located at or around the parking lot. The vehicle monitoring from 360 degree angles may enable the first vehicle to determine if and when an adverse situation associated with the first vehicle may occur, when the first vehicle may be parked. For example, the vehicle monitoring may enable the first vehicle to determine when another vehicle may contact the first vehicle, thereby affecting first vehicle's external appearance and/or performance. The vehicle monitoring from 360 degree angles may further assist a vehicle user or law enforcement personnel to identify an identity of a user who may have driving the other vehicle that contacted the first vehicle, based on the images/videos captured by the additional vehicles and/or the infrastructure sensors.

In some aspects, when the first vehicle may be approaching the parking lot or located at the parking lot, the first vehicle may transmit a monitoring request to a parking assist server. The monitoring request may indicate that the vehicle user desires the first vehicle to be monitored from 360 degree angles, when the first vehicle may be parked at the parking lot. Responsive to receiving the monitoring request, the parking assist server may recommend one or more parking spots to the first vehicle, where a probability of enabling full vehicle monitoring may be high. The first vehicle may receive the recommended parking spots, and then move towards a parking spot (from the recommended parking spots). In some aspects, some or all of the parking assist server functions may be performed by the first vehicle.

When the first vehicle may be parked at the parking spot, the first vehicle may transmit a surveillance request to a first set of additional vehicles and/or a first set of infrastructure sensors that may be located within a first radius from the first vehicle. The first vehicle may then receive images/videos/field of views (FOVs) of the first vehicle captured by the first set of additional vehicles and/or the first set of infrastructure sensors, responsive to transmitting the surveillance request. The first vehicle may then determine if all the vehicle sides may be getting monitored/captured based on the received images/videos/FOVs.

Responsive to determining that all vehicle sides may not be getting monitored, the first vehicle may transmit the surveillance request to a second set of additional vehicles and/or a second set of infrastructure sensors that may be located within a second radius from the first vehicle. The second radius may be greater than the first radius. The first vehicle may then receive the images/videos/FOVs of the first vehicle captured by the second set of additional vehicles and/or the second set of infrastructure sensors. The first vehicle may then again determine if all the vehicle sides may be getting monitored/captured based on the received images/videos/FOVs

Responsive to determining that all the vehicle sides may not be getting monitored, the first vehicle may move towards another parking spot in the parking lot, where a probability of getting all the vehicle sides monitored may be high. On the other hand, responsive to determining that all the vehicle sides may be getting monitored, the first vehicle may get parked at the parking spot.

When the first vehicle may be parked at the parking spot, the first vehicle may continuously (or at a predefined frequency) receive the inputs (e.g., images, videos, etc.) from one or more additional vehicles that may be parked in proximity to the first vehicle and/or one or more infrastructure sensors. Responsive to receiving the inputs, the first vehicle may determine if and when an adverse situation may be encountered by the first vehicle based on the received inputs. The first vehicle may transmit the received inputs to a user device associated with the vehicle user and/or a server associated with the law enforcement personnel, when the first vehicle determines that an adverse situation associated with the first vehicle may have occurred. The vehicle user and/or the law enforcement personnel may use the inputs to identify an identity of a user who may have caused the adverse situation, and take further actions.

In further aspects, the first vehicle may transmit assistance requests to user devices and/or servers associated with tow assistance firms, vehicle maintenance firms, insurance firms, transportation firms, and/or the like, to help the vehicle user deal with the adverse situation.

The present disclosure discloses a system and method that enables monitoring of a vehicle from 360 degree angles, when the vehicle may be parked. Further, the system enables the vehicle user and/or law enforcement personnel to conveniently identify an identity of a user who may have caused the adverse situation associated with the parked vehicle, and take timely remedial actions.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

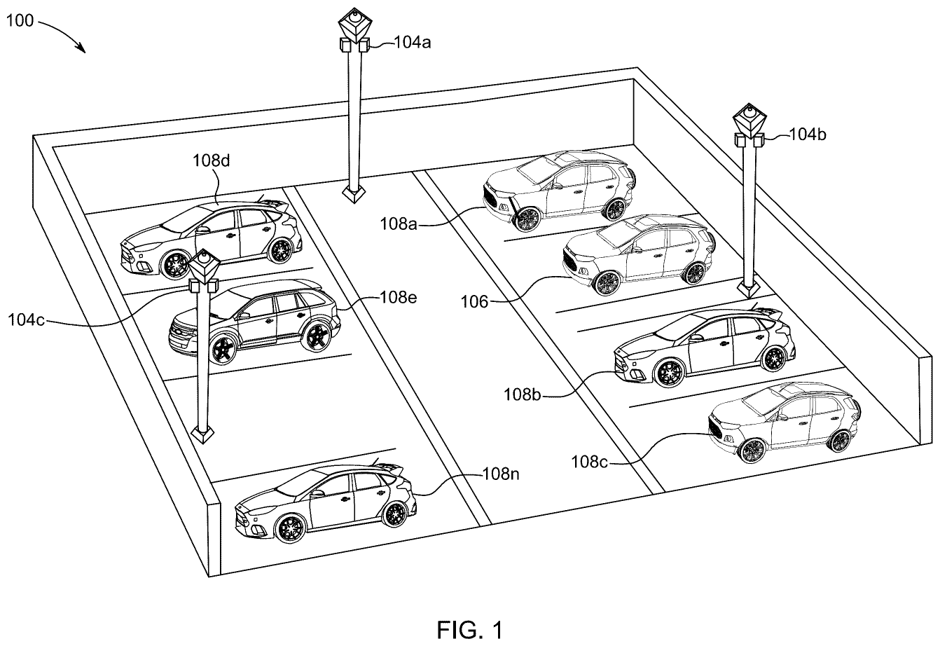

FIG. 1 depicts an example environment 100 in which techniques and structures for providing the systems and methods disclosed herein may be implemented. The environment 100 may include a parking lot 102 or a geographical area where a plurality of users may park their vehicles. The parking lot 102 may include one or more infrastructure sensors 104a, 104b, 104c (collectively referred to as infrastructure sensors 104) that may include cameras, radio detection and ranging (radar) sensors, light detection and ranging (lidar) sensors, and/or the like. The infrastructure sensors 104 may be configured to capture videos and/or images of the parking lot 102 in respective infrastructure sensor's field of view (FOV). In the exemplary aspect depicted in FIG. 1, the infrastructure sensors 104 are shown as being part of lampposts; however, the present disclosure is not limited to such an aspect. The infrastructure sensors 104 may be disposed anywhere in or around the parking lot 102, without departing from the present disclosure scope.

The environment 100 may further include a vehicle 106 and a plurality of additional vehicles 108a, 108b, 108c, 108d, 108e, 108n (collectively referred to as additional vehicles 108) that may be parked at the parking lot 102. In an exemplary aspect, the vehicles 108a and 108b may be located closest to the vehicle 106, and the vehicles 108c, 108d, 108e and 108n may be located farther away from the vehicle 106. For example, the vehicles 108a and 108b may be located within a first predefined distance or a “first radius” (e.g., within 5 to 8 meters) from the vehicle 106, and the vehicles 108c, 108d, 108e and 108n may be located within a second predefined distance or a “second radius” (e.g., 8 to 20 meters) from the vehicle 106. In further aspects, the infrastructure sensors 104a and 104b may be located within the first radius from the vehicle 106, and the infrastructure sensor 104c may be located within the second radius from the vehicle 106. In some aspects, the second radius may be greater than the first radius.

The vehicle 106 may be configured to obtain inputs from one or more additional vehicles 108 and/or one or more infrastructure sensors 104 when the vehicle 106 may be parked at the parking lot 102, and determine that the vehicle 106 may have encountered an adverse situation based on the obtained inputs. For example, the vehicle 106 may determine that a vehicle or an object may have contacted an exterior surface of the vehicle 106 (thereby potentially affecting an exterior vehicle appearance and/or vehicle performance) based on the obtained inputs when the vehicle 106 may be parked. The inputs may be, for example, videos and/or images of the exterior portion of the vehicle 106 that the additional vehicles 108 and the infrastructure sensors 104 may have captured. In some aspects, one or more additional vehicles 108 and/or one or more infrastructure sensors 104 may be configured to capture videos and/or images from all sides/angles of the vehicle 106 (i.e., from 360 angles), thereby enabling the vehicle 106 to efficiently determine occurrence of an adverse situation that may have occurred on any part/portion of the vehicle 106.

In some aspects, a user associated with the vehicle 106, the vehicle 106 and/or authorities (e.g., police) may analyze the inputs (e.g., the videos and/or images) provided by one or more additional vehicles 108 and/or one or more infrastructure sensors 104 to determine an identity of the vehicle/object that may have contacted the vehicle 106, and then take further action. A person ordinarily skilled in the art may appreciate that since the user may not always be present in vicinity of the vehicle 106 when the vehicle 106 may encounter an adverse situation, the inputs from the additional vehicles 108 and/or the infrastructure sensors 104 may assist the user in identifying the vehicle/object that may have caused the adverse situation. In addition, the inputs from the additional vehicles 108 and/or the infrastructure sensors 104 may further assist the user and/or the authorities to capture moments/image frames when the vehicle/object that may have caused the adverse situation approaches in proximity to the vehicle 106 and then leaves the scene. Such moments/image frames may further enable the user and/or the authorities to confirm/ascertain the vehicle/object identity and may hence result in speedy further actions.

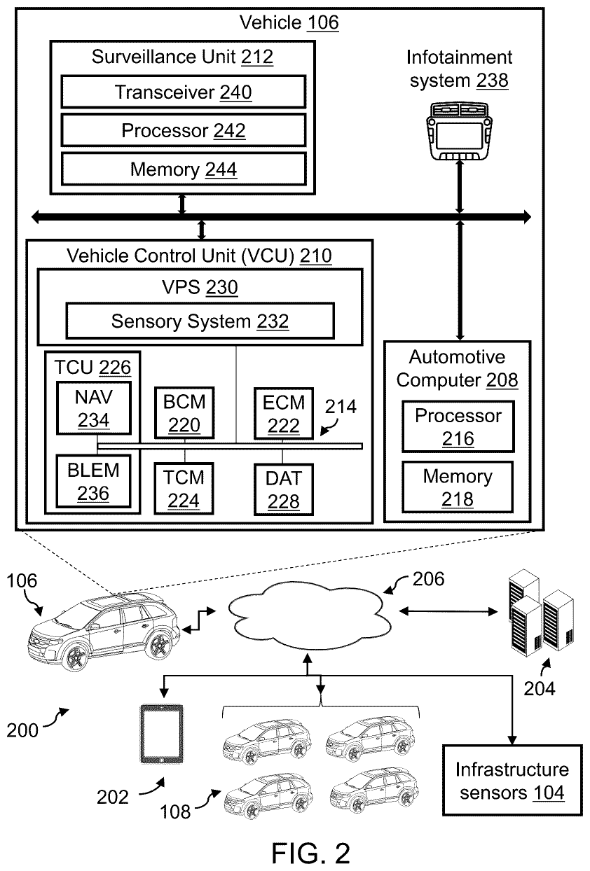

To enable the vehicle 106 to efficiently obtain inputs from the additional vehicles 108 and/or the infrastructure sensors 104 that may assist the user and/or the authorities in case of an adverse situation, the vehicle 106 may first transmit a monitoring request to a parking assist system or server (shown as server 204 in FIG. 2) when the vehicle 106 may be approaching the parking lot 102 or located at the parking lot. The monitoring request may indicate to the parking assist server that the user associated with the vehicle 106 desires the vehicle 106 to be monitored from all angles or vehicle sides (e.g., front, rear, left and right sides).

Responsive to receiving the monitoring request from the vehicle 106, the parking assist server may identify one or more recommended (and vacant) parking spots in the parking lot 102 where a probability of vehicle monitoring from all angles or each vehicle side may be possible. In some aspects, the recommended parking spots may be those parking spots that may have an abundance of the additional vehicles 108 and/or the infrastructure sensors 104 in proximity, which may efficiently provide the inputs (i.e., captured videos and images of the vehicle 106) to the vehicle 106. In an exemplary aspect, if the travel route associated with the vehicle 106 and/or a user preferred parking spot is already known by the parking assist server based on historical vehicle travel data, the parking assist server may enable the additional vehicles 108 to be parked in proximity to the parking spot usually preferred by the user associated with the vehicle 106. In further aspects, the vehicle 106 and/or the additional vehicles 108 may be parked in that area of the parking lot 102 that may be a geo-fenced “surveillance” area.

Responsive to identifying the recommended parking spots, the parking assist server may transmit information associated with the recommended parking spots to the vehicle 106. In some aspects, some or all parking assist server functions may also be performed by the vehicle 106.

The vehicle 106 may autonomously move towards a parking spot (from the recommended parking spots) in the parking lot 102 responsive to receiving the information associated with the recommended parking spots from the parking assist server, or the user may drive the vehicle 106 towards the parking spot. When the vehicle 106 may be parked/located at the parking spot, the vehicle 106 may transmit a surveillance request to one or more additional vehicles 108 (e.g., the additional vehicles 108a, 108b) and/or one or more infrastructure sensors 104 (e.g., the infrastructure sensors 104a, 104b) that may be closest to the vehicle 106. Specifically, the vehicle 106 may broadcast the surveillance request to a first set of additional vehicles (e.g., the vehicles 108a, 108b) and/or a first set of infrastructure sensors (e.g., the infrastructure sensors 104a, 104b) that may be located within the first radius from the vehicle 106. In some aspects, responsive to broadcasting the surveillance request, the vehicle 106 may monitor what infrastructure sensors and/or other vehicles based surveillance sources may be available (or presence of infrastructure sensors and/or other vehicles) by communicating/transmitting the GPS location, the color/brand/trim/other vehicle visual description, etc. associated with the vehicle 106 (which may be part of the surveillance request, or transmitted separately).

Responsive to receiving the surveillance request, the additional vehicles 108a, 108b and/or the infrastructure sensors 104a, 104b may transmit their respective inputs (e.g., videos/images/field of view (FOV) of the vehicle 106) to the vehicle 106. Stated another way, the additional vehicles 108a, 108b and/or the infrastructure sensors 104a, 104b may transmit the videos/images/field of view (FOV) of the vehicle 106 captured by these vehicles/sensors to the vehicle 106, responsive to receiving the surveillance request from the vehicle 106.

The vehicle 106 may analyze the inputs received from the additional vehicles 108a, 108b and/or the infrastructure sensors 104a, 104b, and determine whether all sides/angles of the vehicle 106 are getting captured/covered by the received inputs. If the vehicle 106 determines that all the vehicle sides/angles may not be getting captured, the vehicle 106 may increase the perimeter/radius of the surveillance request broadcast/transmission, and may transmit/broadcast the surveillance request to the additional vehicles 108 and/or the infrastructure sensors 104 that may be located within the second radius from the vehicle 106. Responsive to transmitting the surveillance request in the second radius, the vehicle 106 may obtain inputs from the additional vehicles 108c, 108d, 108e and 108n and/or the infrastructure sensor 104c. The vehicle 106 may again analyze the received inputs, and determine whether all sides/angles of the vehicle 106 are getting captured/covered by the received inputs. The vehicle 106 may park the vehicle 106 at the parking spot when the vehicle 106 determines that all the vehicle sides/angles may be getting captured/covered based on the received inputs. On the other hand, the vehicle 106 may autonomously move towards another parking spot in the parking lot 102 (that may offer a better probability of vehicle surveillance from all vehicle sides/angles) when the vehicle 106 determines that all vehicle sides/angles may not be getting captured/covered based on the received inputs.

In some aspects, one or more additional vehicles 108 may not share their inputs to the vehicle 106 responsive to receiving the surveillance request from the vehicle 106. Specifically, the surveillance request may include one or more incentives (e.g., a predefined payment, an offer for reciprocal monitoring, a discount offer for one or more services, etc.) that the user associated with the vehicle 106 and/or a third party (e.g., a parking lot owner) may offer to the additional vehicles 108 that provide their inputs to the vehicle 106. If a user associated with an additional vehicle 108 does not desire to share the inputs with the vehicle 106 or desires greater incentives, that particular additional vehicle 108 may not transmit its inputs to the vehicle 106. In this case, if required, the user associated with the vehicle 106 and/or the third party may increase the incentives offered to the additional vehicle 108 (when, for example, inputs from other vehicles may not provide vehicle surveillance from all the vehicle sides/angles).

In further aspects, if multiple additional vehicles 108 provide same or similar external view of the vehicle 106, the vehicle 106 may receive inputs from only that additional vehicle 108 that provides better image/video quality or a better view associated with the vehicle 106.

When the vehicle 106 determines that all vehicle sides/angles may be getting captured/covered based on the received inputs, the vehicle 106 may be parked at the parking spot in the parking lot 102. The vehicle 106 may then continuously (or at a predefined frequency) receive inputs from one or more additional vehicles 108 and/or one or more infrastructure sensors 104 (that provide 360 degree view of the vehicle 106), and determine whether an adverse situation may have occurred associated with the vehicle 106 based on the inputs. The adverse situation may be, e.g., when a vehicle or an object makes contact with the parked vehicle 106.

Although the description above describes as aspect where the vehicle 106 determines that the adverse situation may have occurred based on the inputs received from the additional vehicles 108 and/or the infrastructure sensors 104, in alternative or additional aspects, the additional vehicles 108 and/or the infrastructure sensors 104 may themselves analyze their respective inputs to determine if an adverse situation may have occurred associated with the vehicle 106. In this case, the additional vehicles 108 and/or the infrastructure sensors 104 may transmit an indication to the vehicle 106 informing about the occurrence of the adverse situation.

Responsive to determining that an adverse situation may have occurred with the vehicle 106, the vehicle 106 may transmit an alert notification, along with the inputs received from the additional vehicles 108 and/or the infrastructure sensors 104, to a user device associated with the vehicle user and/or a server associated with the authorities (e.g., the police). The vehicle user and/or the authorities may then analyze the inputs (i.e., the videos/images associated with the adverse situation) to identify an identity of the vehicle/object that may have contacted the parked vehicle 106.

If required, the vehicle 106 and/or the user device and/or the server associated with the authorities may request additional inputs associated with the adverse situation from the additional vehicles 108 and/or the infrastructure sensors 104. For example, additional videos/images before and after the adverse situation may be requested to ascertain/confirm the vehicle/object identity. As another example, additional videos/images associated with other locations leading up to and leading away from the vehicle 106 may also be monitored in case an adverse situation occurs (so that the approaching/departing vehicle or object that caused the adverse situation may be recorded/identified).

In some aspects, the vehicle 106 may additionally transmit an assistance notification to servers and/or user devices associated with tow assistance companies, vehicle maintenance and repair firms, insurance firms, transportation firms, etc., to facilitate the vehicle user in dealing with the adverse situation.

Further vehicle details are described below in conjunction with FIG. 2.

The vehicle 106 and/or the vehicle user implement and/or perform operations, as described here in the present disclosure, in accordance with the owner manual and safety guidelines. In addition, any action taken by the vehicle user based on recommendations or notifications provided by the vehicle 106 should comply with all the rules specific to the location and operation of the vehicle 106 (e.g., Federal, state, country, city, etc.). The recommendation or notifications, as provided by the vehicle 106, should be treated as suggestions and only followed according to any rules specific to the location and operation of the vehicle 106.

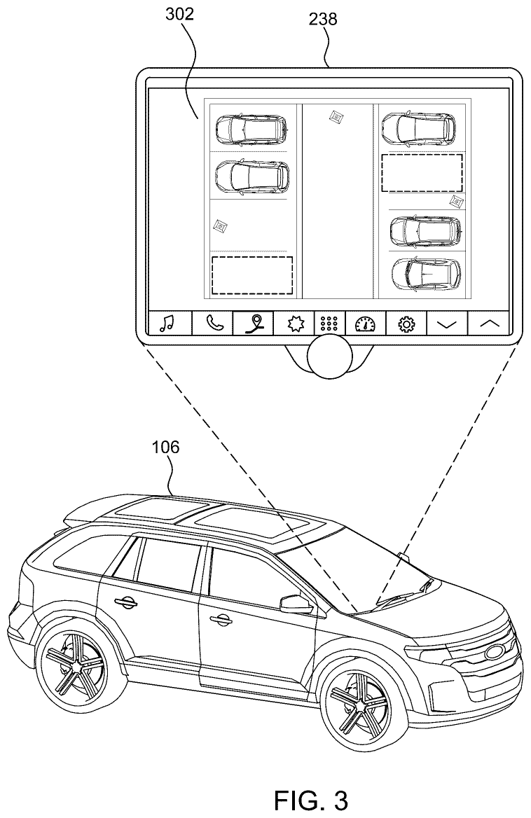

FIG. 2 depicts a block diagram of an example vehicle monitoring system 200 (or system 200) in accordance with the present disclosure. While describing FIG. 2, references will be made to FIGS. 3, 4 and 5.

The system 200 may include the vehicle 106, a user device 202, the additional vehicles 108, the infrastructure sensors 104, and one or more servers 204 (or server 204) communicatively coupled with each other via one or more networks 206 (or network 206). The user device 202 may be associated with the vehicle user of the vehicle 106, and may be, for example, a mobile phone, a laptop, a computer, a tablet, a smartwatch, a wearable device, or any other device with communication capabilities.

The server 204 may be part of a cloud-based computing infrastructure and may be associated with and/or include a Telematics Service Delivery Network (SDN) that provides digital data services to the vehicle 106, the additional vehicles 108 and other vehicles (not shown) that may be part of a vehicle fleet. In further aspects, the server 204 may be an “authorities server”, and may be associated with the authorities such as the police or law enforcement personnel. In additional aspects, the server 204 may be an assistance server, and may be associated with at least one of a tow assistance firm, a vehicle maintenance and repair firm, an insurance firm and a transportation firm. In yet another aspect, the server 204 may be a parking assist server, and may be associated with a firm that provides parking related assistance and/or navigation services to a plurality of vehicles.

The network 206 illustrates an example communication infrastructure in which the connected devices discussed in various embodiments of this disclosure may communicate. The network 206 may be and/or include the Internet, a private network, public network or other configuration that operates using any one or more known communication protocols such as, for example, transmission control protocol/Internet protocol (TCP/IP), Bluetooth®, Bluetooth® low Energy (BLE), Wi-Fi based on the Institute of Electrical and Electronics Engineers (IEEE) standard 802.11, ultra-wideband (UWB), and cellular technologies such as Time Division Multiple Access (TDMA), Code Division Multiple Access (CDMA), High-Speed Packet Access (HSPDA), Long-Term Evolution (LTE), Global System for Mobile Communications (GSM), and Fifth Generation (5G), to name a few examples.

The vehicle 106 may include a plurality of units including, but not limited to, an automotive computer 208, a Vehicle Control Unit (VCU) 210, and a surveillance unit 212 (or unit 212). The VCU 210 may include a plurality of Electronic Control Units (ECUs) 214 disposed in communication with the automotive computer 208.

In some aspects, the user device 202 may be configured to connect with the automotive computer 208 and/or the unit 212 via the network 206, which may communicate via one or more wireless connection(s), and/or may connect with the vehicle 106 directly by using near field communication (NFC) protocols, Bluetooth® protocols, Wi-Fi, Ultra-Wide Band (UWB), and other possible data connection and sharing techniques.

The automotive computer 208 and/or the unit 212 may be installed anywhere in the vehicle 106, in accordance with the disclosure. Further, the automotive computer 208 may operate as a functional part of the unit 212. The automotive computer 208 may be or include an electronic vehicle controller, having one or more processor(s) 216 and a memory 218. Moreover, the unit 212 may be separate from the automotive computer 208 (as shown in FIG. 2) or may be integrated as part of the automotive computer 208.

The processor(s) 216 may be disposed in communication with one or more memory devices disposed in communication with the respective computing systems (e.g., the memory 218 and/or one or more external databases not shown in FIG. 2). The processor(s) 216 may utilize the memory 218 to store programs in code and/or to store data for performing operations in accordance with the disclosure. The memory 218 may be a non-transitory computer-readable storage medium or memory storing a vehicle surveillance program code. The memory 218 may include any one or a combination of volatile memory elements (e.g., dynamic random-access memory (DRAM), synchronous dynamic random-access memory (SDRAM), etc.) and may include any one or more nonvolatile memory elements (e.g., erasable programmable read-only memory (EPROM), flash memory, electronically erasable programmable read-only memory (EEPROM), programmable read-only memory (PROM), etc.).

In accordance with some aspects, the VCU 210 may share a power bus with the automotive computer 208 and may be configured and/or programmed to coordinate the data between vehicle systems, connected servers (e.g., the server 204), the additional vehicles 108, the infrastructure sensors 104, and/or the like. The VCU 210 may include or communicate with any combination of the ECUs 214, such as, for example, a Body Control Module (BCM) 220, an Engine Control Module (ECM) 222, a Transmission Control Module (TCM) 224, a telematics control unit (TCU) 226, a Driver Assistances Technologies (DAT) controller 228, etc. The VCU 210 may further include and/or communicate with a Vehicle Perception System (VPS) 230, having connectivity with and/or control of one or more vehicle sensory system(s) 232. The vehicle sensory system 232 may include one or more vehicle sensors including, but not limited to, a Radio Detection and Ranging (RADAR or “radar”) sensor configured for detection and localization of objects inside and outside the vehicle 106 using radio waves, sitting area buckle sensors, sitting area sensors, a Light Detecting and Ranging (“lidar”) sensor, door sensors, proximity sensors, temperature sensors, wheel sensors, one or more ambient weather or temperature sensors, vehicle interior and exterior cameras, steering wheel sensors, etc.

In some aspects, the VCU 210 may control vehicle operational aspects and implement one or more instruction sets received from the server 204, the user device 202, from one or more instruction sets stored in the memory 218, including instructions operational as part of the unit 212.

The TCU 226 may be configured and/or programmed to provide vehicle connectivity to wireless computing systems onboard and off board the vehicle 106, and may include a Navigation (NAV) receiver 234 for receiving and processing a GPS signal, a BLE® Module (BLEM) 236, a Wi-Fi transceiver, a UWB transceiver, and/or other wireless transceivers (not shown in FIG. 2) that may be configurable for wireless communication (including cellular communication) between the vehicle 106 and other systems (e.g., a vehicle key fob (not shown in FIG. 2), the server 204, the user device 202, the additional vehicles 108, the infrastructure sensors 104, etc.), computers, and modules. The TCU 226 may be disposed in communication with the ECUs 214 by way of a bus. In some aspects, the TCU 226 may be configured to determine a real-time vehicle geolocation, e.g., via the NAV receiver 234.

The ECUs 214 may control aspects of vehicle operation and communication using inputs from human drivers, inputs from the automotive computer 208, the unit 212, and/or via wireless signal inputs received via the wireless connection(s) from other connected devices, such as the server 204, among others.

The BCM 220 generally includes integration of sensors, vehicle performance indicators, and variable reactors associated with vehicle systems, and may include processor-based power distribution circuitry that may control functions associated with the vehicle body such as lights, windows, security, camera(s), audio system(s), speakers, wipers, door locks and access control, various comfort controls, etc. The BCM 220 may also operate as a gateway for bus and network interfaces to interact with remote ECUs (not shown in FIG. 2).

The DAT controller 228 may provide Level-1 through Level-3 automated driving and driver assistance functionality that may include, for example, active parking assistance, vehicle backup assistance, and/or adaptive cruise control, among other features. The DAT controller 228 may also provide aspects of user and environmental inputs usable for user authentication.

In some aspects, the automotive computer 208 may connect with an infotainment system 238 (or a vehicle Human-Machine Interface (HMI)). The infotainment system 238 may include a touchscreen interface portion, and may include voice recognition features, biometric identification capabilities that may identify users based on facial recognition, voice recognition, fingerprint identification, or other biological identification means. In other aspects, the infotainment system 238 may be further configured to receive user instructions via the touchscreen interface portion, and/or output or display notifications, navigation maps, etc. on the touchscreen interface portion.

The computing system architecture of the automotive computer 208, the VCU 210, and/or the unit 212 may omit certain computing modules. It should be readily understood that the computing environment depicted in FIG. 2 is an example of a possible implementation according to the present disclosure, and thus, it should not be considered as limiting or exclusive.

In accordance with some aspects, the unit 212 may be integrated with and/or executed as part of the ECUs 214. The unit 212, regardless of whether it is integrated with the automotive computer 208 or the ECUs 214, or whether it operates as an independent computing system in the vehicle 106, may include a transceiver 240, a processor 242, and a computer-readable memory 244.

The transceiver 240 may be configured to receive information/inputs from one or more external devices or systems, e.g., the user device 202, the server 204, the additional vehicles 108, the infrastructure sensors 104, and/or the like, via the network 206. Further, the transceiver 240 may transmit notifications, requests, signals, etc. to the external devices or systems. In addition, the transceiver 240 may be configured to receive information/inputs from vehicle components such as the vehicle sensory system 232, one or more ECUs 214, and/or the like. Further, the transceiver 240 may transmit signals (e.g., command signals) or notifications to the vehicle components such as the BCM 220, the infotainment system 238, and/or the like.

The processor 242 and the memory 244 may be same as or similar to the processor 216 and the memory 218, respectively. In some aspects, the processor 242 may utilize the memory 244 to store programs in code and/or to store data for performing operations in accordance with the disclosure. The memory 244 may be a non-transitory computer-readable storage medium or memory storing the vehicle surveillance program code. In some aspects, the memory 244 may additionally store instructions/information/data obtained from the server 204, the user device 202, the additional vehicles 108, the infrastructure sensors 104, and/or the like.

In operation, when the vehicle 106 may be approaching the parking lot 102 or located at the parking lot 102, the processor 242 may cause the transceiver 240 to transmit a monitoring request to the parking assist server (or the server 204) to monitor each vehicle side or monitor the vehicle 106 from all angles when the vehicle 106 may be parked in the parking lot 102. In some aspects, the processor 242 may determine that the vehicle 106 may be approaching the parking lot 102 or located at the parking lot 102 based on a real-time vehicle geolocation (as obtained via the NAV receiver 234) and a parking lot location (which may be pre-stored in the memory 244 or obtained from the server 204).

The server 204 may receive the monitoring request from the vehicle 106, and may identify one or more recommended (and available/vacant) parking spots in the parking lot 102 where the vehicle 106 may be parked based on locations in the parking lot 102 where the additional vehicles 108 may already be parked, infrastructure sensor locations and/or historical user preferred parking spots. In some aspects, the recommended parking spots may be those parking spots in the parking lot 102 that may have a high probability of enabling a vehicle monitoring from each vehicle side. Specifically, the recommended parking spots may be those parking spots where many of the additional vehicles 108 may be parked and/or those parking spots that provide a clear view to one or more infrastructure sensors 104. In some aspects, vehicle surveillance/monitoring from all angles may be realized by the infrastructure sensors 104 alone, the additional vehicles 108 alone, or a combination of one or more additional vehicles 108 and one or more infrastructure sensors 104. As described above in conjunction with FIG. 1, the infrastructure sensors 104 may be cameras, radar sensors, lidar sensors, and/or the like.

In some aspects, when the server 204 already has access to historical user preferred parking spots associated with the vehicle 106 or access to vehicle's travel route, the server 204 may “pre-arrange” the additional vehicles 108 in the parking lot 102, and accordingly identify the recommended parking spots such that the recommended parking spots include the user preferred parking spots (or parking spots in the vehicle's travel route). In further aspects, the recommended parking spots may be in an area of the parking lot 102 that may be a geo-fenced surveillance area.

Responsive to identifying the recommended parking spots, the server 204 may transmit information associated with the recommended parking spots to the vehicle 106 via the network 206. The processor 242 may obtain the information associated with the recommended parking spots from the server 204 (via the transceiver 240), and display the obtained information on the user device 202 and/or the infotainment system 238, as shown in FIG. 3. As depicted in an exemplary view 302 of FIG. 3, the information associated with the recommended parking spots may include a map associated with the parking lot 102 with the recommended parking spot locations highlighted for user's convenience.

The vehicle user may view the recommended parking spots on the user device 202 and/or the infotainment system 238, and select a parking spot from the recommended parking spots to park the vehicle 106. The vehicle user may then drive to the selected parking spot to park the vehicle 106. In some aspects, the server 204 may further provide navigation instructions to assist the vehicle user to reach to the selected parking spot. If the vehicle 106 is an autonomous vehicle, the processor 242 may cause the vehicle 106 to autonomously move towards a recommended parking spot (from the recommended parking spots) or the selected parking spot, responsive to obtaining the information associated with the recommended parking spots from the server 204.

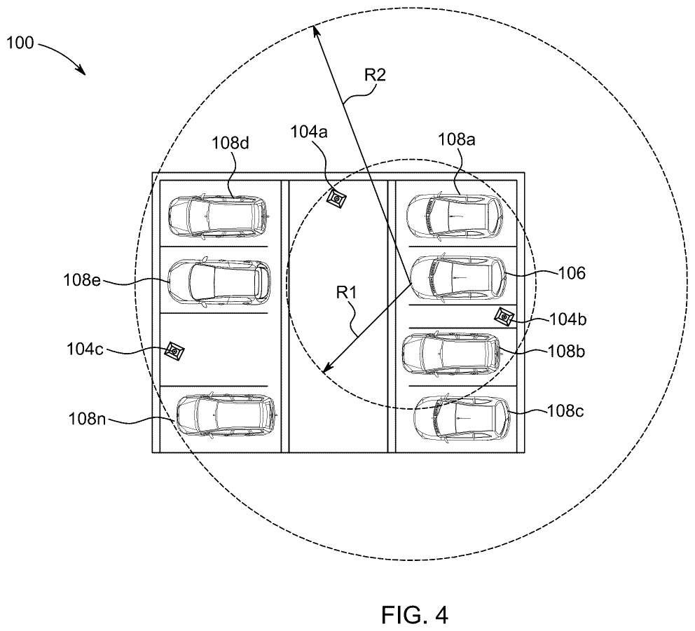

When the vehicle 106 may be parked at a parking spot (e.g., the parking spot selected by the vehicle user) in the parking lot 102, the transceiver 240 may transmit/broadcast a surveillance request to a first set of additional vehicles and/or a first set of infrastructure sensors that may be located within a first radius “R1” from the vehicle 106, as shown in FIG. 4. In an exemplary aspect, the first set of additional vehicles may include the additional vehicles 108a, 108b, and the first set of infrastructure sensors may include the infrastructure sensors 104a, 104b. The transceiver 240 may further transmit/communicate Global Positioning System (GPS) location and vehicle visual description associated with the vehicle 106, in addition to or as part of the surveillance request.

In some aspects, the surveillance request may include a geolocation of the vehicle 106, vehicle identifiers such as model, brand, color, etc. associated with the vehicle 106, information associated with one or more incentives to be offered to the first set of additional vehicles in lieu of their inputs (e.g., videos, images, etc.), and/or the like. The incentives may be, for example, reciprocal monitoring, a form of payment (that may be paid by the vehicle user, the firm operating the server 204, a third party, and/or the like), a discount for some service, etc.

Responsive to receiving the surveillance request, one or more additional vehicles (e.g., the additional vehicles 108a and/or 108b) from the first set of additional vehicles may accept the surveillance request, and transmit their respective inputs (or “first inputs”) to the transceiver 240. Similarly, the infrastructure sensors 104a, 104b from the first set of infrastructure sensors may transmit their respective inputs (or the first inputs) to the transceiver 240. In some aspects, the inputs from the additional vehicles 108 and the infrastructure sensors 104 may include videos and/or images of the vehicle 106 in the parked position captured by the additional vehicles 108 and the infrastructure sensors 104, and respective field of views (FOVs).

The transceiver 240 may receive the first inputs described above from the additional vehicles 108a and/or 108b, and/or the infrastructure sensors 104a, 104b, and transmit the first inputs to the processor 242. In some aspects, the transceiver 240 may receive the first inputs via the network 206, vehicle-to-vehicle (V2V) communicating and/or vehicle-to-infrastructure (V2I) communication. The processor 242 may obtain the first inputs, and may analyze the first inputs, e.g., by using Artificial Intelligence/Machine Learning (AI/ML) based algorithms that may be pre-stored in the memory 244. The processor 242 may further monitor a presence of the additional vehicles 108a and/or 108b, and/or the infrastructure sensors 104a, 104b, responsive to the transceiver 240 communicating the GPS location and the vehicle visual description of the vehicle 106.

In some aspects, the processor 242 may determine that a first predefined condition may be met based on the first input analysis. In an exemplary aspect, the processor 242 may determine that the first predefined condition may be met when the processor 242 determines that each vehicle side may not be getting monitored/captured/covered based on the first inputs or the vehicle 106 may not be getting surveillance or monitoring from all the vehicle angles (i.e., from 360 degree angles) based on the first inputs.

Responsive to determining that the first predefined condition may be met, the processor 242 may cause the transceiver 240 to transmit/broadcast the surveillance request to a second set of additional vehicles and/or a second set of infrastructure sensors that may be located within a second radius “R2” from the vehicle 106, as shown in FIG. 4. As shown in FIG. 4, the second radius “R2” may be greater than the first radius “R1”. In this manner, responsive to determining that the first predefined condition may be met, the processor 242 may increase/extend the perimeter or radius associated with the surveillance requests, so that it reaches to more vehicles and/or infrastructure sensors. In an exemplary aspect, the second set of additional vehicles may include (in addition to the first of additional vehicles) the additional vehicles 108c, 108d, 108e and 108n. Similarly, the second set of infrastructure sensors may include (in addition to the first of infrastructure sensors) the infrastructure sensor 104c.

Responsive to receiving the surveillance request from the transceiver 240, one or more additional vehicles from the second set of additional vehicles may accept the surveillance request (as described above), and transmit their respective inputs (or “second inputs”, which may be similar to the first inputs) to the transceiver 240. In some aspects, the surveillance request that may be transmitted by the transceiver 240 to the second set of additional vehicles (and the second set of infrastructure sensors) may have/include the same amount/level of incentives as offered to the first set of additional vehicles (and the first set of infrastructure sensors). In other aspects, the surveillance request that may be transmitted by the transceiver 240 to the second set of additional vehicles (and the second set of infrastructure sensors) may have/include a greater amount/level of incentives as compared to the incentives offered to the first set of additional vehicles (and the first set of infrastructure sensors). In this case, the processor 242 may increase the amount/level of incentives to incentivize more vehicles to accept the surveillance request and transmit their respective inputs to the transceiver 240.

In a manner similar to the second set of additional vehicles, one or more infrastructure sensors from the second set of infrastructure sensors may transmit their respective inputs (or the second inputs) to the transceiver 240.

The transceiver 240 may receive the second inputs from one or more additional vehicles from the second set of additional vehicles and one or more infrastructure sensors from the second set of infrastructure sensors, and transmit the second inputs to the processor 242. The processor 242 may obtain the second inputs from the transceiver 240, and analyze the second inputs by using the AI/ML based algorithms that may be stored in the memory 244. Based on the second input analysis, the processor 242 may determine whether the first predefined condition may be met or may not be met. Stated another way, the processor 242 may determine whether all the vehicle sides may be getting monitored/captured based on the second inputs.

Responsive to determining that the first predefined condition may be met based on the second inputs, the processor 242 may either cause the transceiver 240 to transmit/broadcast another surveillance request with higher incentives and/or at a bigger perimeter/radius than the second radius “R2”, or cause the vehicle 106 to relocate to another known parking spot that may provide a higher probability of vehicle monitoring from all angles (or a better vehicle view). In the latter case, the processor 242 may transmit an instruction to the user device 202 and/or the infotainment system 238, requesting the vehicle user to drive to the other parking spot. In some aspects, the processor 242 may further output navigation instructions (as obtained from the server 204) on the user device 202 and/or the infotainment system 238, to facilitate the vehicle user to conveniently drive to the other parking spot. If the vehicle 106 is an autonomous vehicle, the processor 242 may cause the vehicle 106 to autonomously move to the other parking spot. The processor 242 may repeat the same process of transmitting/broadcasting surveillance requests at the other parking spot, till the processor 242 determines that all the vehicle sides may be getting monitored.

On the other hand, responsive to determining that the first predefined condition may not be met based on the second inputs (or the first inputs), the processor 242 may determine that the vehicle 106 may be getting monitored from all the angles/sides at the current parking spot. In this case, the vehicle 106 may get parked at the current parking spot. In this case, the processor 242 may further determine if multiple additional vehicles 108 and/or infrastructure sensors 104 may be providing similar vehicle view. In this case, the processor 242 may select only those additional vehicles and/or infrastructure sensors to further receive first/second inputs that provide higher quality images/videos to the vehicle 106 (i.e., select those vehicles/sensors that have a higher resolution camera, radar sensor, and/or the like).

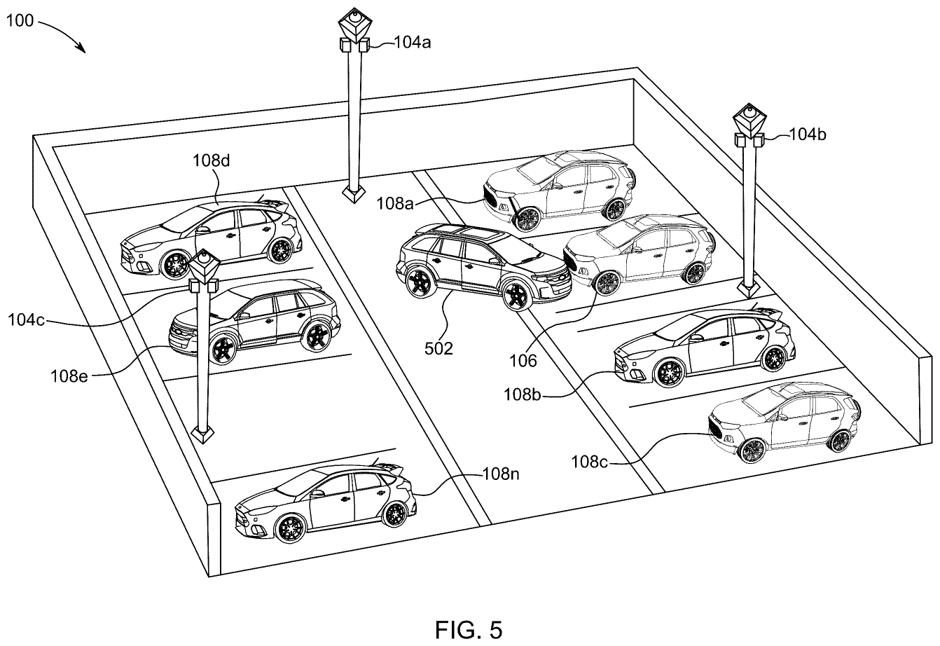

When the vehicle 106 may be parked at the parking spot, the processor 242 may continue to obtain inputs (e.g., the first and/or second inputs) from one or more additional vehicles 108 and/or one or more infrastructure sensors 104 continuously or at a predefined frequency. Responsive to receiving the inputs when the vehicle 106 may be parked, the processor 242 may analyze the inputs and determine if a second predefined condition may be met. In some aspects, the processor 242 may determine that the second predefined condition may be met when the vehicle 106 parked at the parking spot meets with an adverse situation. Stated another way, the second predefined condition may be met when an adverse situation associated with the vehicle 106 may be detected based on the inputs received from one or more additional vehicles 108 and/or one or more infrastructure sensors 104, as shown in FIG. 5. As depicted in FIG. 5, a vehicle 502 may have contacted the parked vehicle 106. The processor 242 may determine that the second predefined condition may be met when such an adverse situation may be detected based on the obtained inputs. In an exemplary aspect, the processor 242 may detect such an adverse situation associated with the vehicle 106 when the vehicle 106 may be unoccupied and a vehicle movement of a predefined distance may be identified based on the obtained inputs (and inputs obtained from a vehicle accelerometer). A person ordinarily skilled in the art may appreciate that if the vehicle 106 is unoccupied and the vehicle 106 moves by a small distance, a probability of the vehicle 106 being contacted by another vehicle (e.g., the vehicle 502) or an object may be high.

Although the description above describes an aspect where the processor 242 determines that the second predefined condition may be met based on the obtained inputs, in alternative or additional aspects, one or more additional vehicles 108 and/or one or more infrastructure sensors 104 may themselves analyze their respective inputs and provide an indication (e.g., transmit an alert notification) to the processor 242 that the second predefined condition may have been met. In this case, each additional vehicle and/or infrastructure sensor may use their onboard computers and the AI/ML based algorithms to determine the occurrence of the second predefined condition.

Responsive to determining that the second predefined condition may be met, the processor 242 may cause the transceiver 240 to transmit the inputs obtained from one or more additional vehicles 108 and/or one or more infrastructure sensors 104 to the user device 202 and/or the server 204 (or the police). Stated another way, the processor 242 may transmit the recorded videos/images to the user device 202 and/or the server 204, when an adverse situation associated with the vehicle 106 may be detected. Responsive to receiving/viewing the recording, the vehicle user and/or the law enforcement personnel may determine a user identity associated with the vehicle 502, the vehicle's license plate number, and/or the like.

The processor 242 may further generate an adverse situation description data structure based on the obtained inputs and one or more additional inputs obtained from one or more users who may be located in proximity to the vehicle 106, when the adverse situation may have occurred. The adverse situation description data structure may be generated by using a large language model (LLM) based on the description of the adverse situation as seen/explained by one or more witnesses who may have been present in proximity to the parking lot 102 when the adverse situation may have occurred. The description may include, for example, information associated with an effect on the vehicle 106 caused due to the adverse situation, a type, speed, model of the vehicle 502, an identify of a user who may be driving the vehicle 502, and/or the like. Responsive to generating the adverse situation description data structure, the processor 242 may cause the transceiver 240 to transmit the adverse situation description data structure to the user device 202 and/or the server 204. In some aspects, the processor 242 may highlight useful or important parts of the videos/images or witness comments included in the adverse situation description data structure, for vehicle user and/or law enforcement personnel's convenience.

In addition, the processor 242 may transmit, via the transceiver 240, a request for additional inputs associated with the adverse situation to one or more additional vehicles 108 and/or one or more infrastructure sensors 104. The additional inputs may be associated with videos/images captured a first time duration (e.g., 2 or 5 minutes) leading up to the adverse situation and a second time duration (e.g., 2 or 5 minutes) after the adverse situation. The amount of additional videos/images (e.g., the amount of pre-roll time) may depend upon an adverse situation severity and/or when the vehicle 502 may have entered and/or exited the parking lot 102 or an area where the vehicle 106 may be parked. Stated another way, the first time duration and the second time duration may be based on the adverse situation severity.

Responsive to receiving the request, the additional vehicles 108 and/or the infrastructure sensors 104 may transmit the additional inputs to the transceiver 240. In some aspects, each additional vehicle/infrastructure sensor may transmit important video frames/images (containing visuals of the vehicle 502) to the transceiver 240 as part of the additional inputs. The processor 242 may obtain the additional inputs from the transceiver 240, and then cause the transceiver 240 to transmit the additional inputs to the user device 202 and/or the server 204, for vehicle user and/or law enforcement personnel's convenience.

In further aspects, responsive to determining that the second predefined condition may be met, the processor 242 may cause the transceiver 240 to transmit an assistance request to the server 204 that may be associated with a tow assistance firm, a vehicle maintenance and repair firm, an insurance firm and a transportation firm. The tow assistance firm may give a token referral to the adverse situation, when the tow assistance firm gets a towing job. The vehicle maintenance and repair firm may use the videos/images described above, and may request the user driving the vehicle 502 to fund the repair. The vehicle maintenance and repair firm may also provide a quote to the vehicle user for the repair, based on the videos/images described above. The insurance firm may use the videos/images for claim documentation. The transportation firm may provide transportation assistance to the vehicle user if, for example, the vehicle 106 may not be able to travel after encountering the adverse situation.

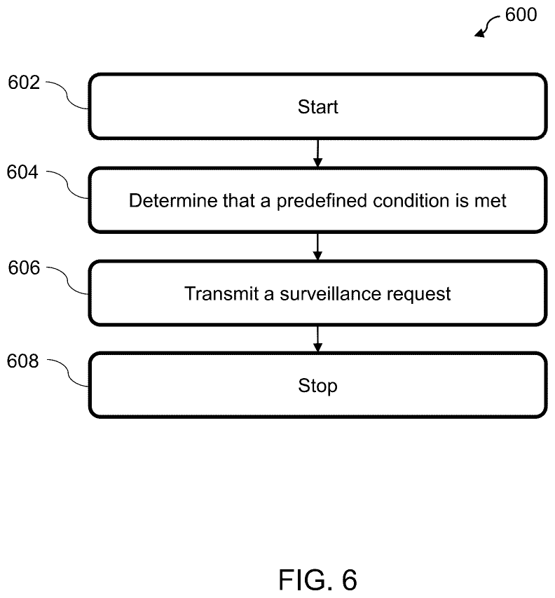

FIG. 6 depicts a flow diagram of an example vehicle monitoring method 600 in accordance with the present disclosure. FIG. 6 may be described with continued reference to prior figures. The following process is exemplary and not confined to the steps described hereafter. Moreover, alternative embodiments may include more or less steps than are shown or described herein and may include these steps in a different order than the order described in the following example embodiments.

The method 600 starts at step 602. At step 604, the method 600 may include determining, by the processor 242, that the first predefined condition may be met based on the first inputs, as described above. At step 606, the method 600 may include transmitting or causing the transceiver 240 to transmit the surveillance request to the second set of vehicles and the second set of infrastructure sensors located within the second radius “R2” from the vehicle 106, responsive to determining that the first predefined condition may be met.

The method 600 may end at step 608.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A first vehicle comprising:
a transceiver configured to:
transmit a surveillance request to at least one of a first set of vehicles or a first set infrastructure sensors located within a first radius from the first vehicle; and
receive first inputs from at least one of a second vehicle from the first set of vehicles or a first infrastructure sensor from the first set of infrastructure sensors responsive to transmitting the surveillance request; and
a processor communicatively coupled with the transceiver, wherein the processor is configured to:
determine that a first predefined condition is met based on the first inputs; and
cause the transceiver to transmit the surveillance request to at least one of a second set of vehicles or a second set of infrastructure sensors located within a second radius from the first vehicle responsive to determining that the first predefined condition is met, wherein the second radius is greater than the first radius.

2. The first vehicle of claim 1, wherein the processor determines that the first predefined condition is met when each vehicle side is not getting monitored based on the first inputs.

3. The first vehicle of claim 1, wherein the transceiver transmits the surveillance request when the first vehicle is located at a parking lot, wherein the transceiver is further configured to communicate a Global Positioning System (GPS) location and vehicle visual description associated with the first vehicle, and wherein the processor is further configured to monitor a presence of the second vehicle or the first infrastructure sensor responsive to the transceiver communicating the GPS location and the vehicle visual description.

4. The first vehicle of claim 1, wherein the first set of infrastructure sensors and the second set of infrastructure sensors comprise at least one of cameras, radar sensors, and lidar sensors.

5. The first vehicle of claim 1, wherein the surveillance request comprises at least one of a first vehicle geolocation and one or more first vehicle identifiers.

6. The first vehicle of claim 5, wherein the surveillance request further comprises information associated with one or more incentives to be offered to the first set of vehicles and the second set of vehicles.

7. The first vehicle of claim 1, wherein the first inputs comprise at least one of a first vehicle video, a first vehicle image and a first vehicle field of view (FOV) captured by the second vehicle or the first infrastructure sensor.

8. The first vehicle of claim 1, wherein the processor is further configured to:
obtain second inputs from a least one of a third vehicle from the second set of vehicles or a second infrastructure sensor from the second set of infrastructure sensors responsive to causing the transceiver to transmit the surveillance request to at least one of the second set of vehicles or the second set of infrastructure sensors;
determine that the first predefined condition is met based on the second inputs; and
cause the first vehicle to relocate from a current location to another location responsive to determining that the first predefined condition is met.

9. The first vehicle of claim 1, wherein the processor is further configured to:
determine that the first predefined condition is not met based on the first inputs;
determine that a second predefined condition is met based on the first inputs; and
cause the transceiver to transmit the first inputs to at least one of an authorities server or a user device, responsive to determining that the second predefined condition is met.

10. The first vehicle of claim 9, wherein the processor determines that the second predefined condition is met when an adverse situation associated with the first vehicle is detected based on the first inputs.

11. The first vehicle of claim 10, wherein the processor detects the adverse situation when the first vehicle is unoccupied and the first vehicle moves by more than a predefined distance.

12. The first vehicle of claim 10, wherein the processor is further configured to:
generate an adverse situation description data structure based on at least one of the first inputs or one or more additional inputs obtained from one or more users located in proximity to the first vehicle; and
cause the transceiver to transmit the adverse situation description data structure to at least one of the authorities server or the user device.

13. The first vehicle of claim 10, wherein the processor is further configured to:
cause the transceiver to transmit a request to the second vehicle or the first infrastructure sensor for additional inputs associated with the adverse situation;
obtain the additional inputs from the second vehicle or the first infrastructure sensor responsive to causing the transceiver to transmit the request; and
cause the transceiver to transmit the additional inputs to at least one of the authorities server or the user device.

14. The first vehicle of claim 13, wherein the additional inputs are associated with at least one of a first time duration leading up to the adverse situation or a second time duration after the adverse situation, and additional videos or images associated with other locations leading up to and leading away from the first vehicle 106.

15. The first vehicle of claim 14, wherein the first time duration and the second time duration are based on a severity of the adverse situation.

16. The first vehicle of claim 9, wherein the processor is further configured to cause the transceiver to transmit an assistance request to an assistance server responsive to determining that the second predefined condition is met, and wherein the assistance server is associated with at least one of a tow assistance firm, a vehicle maintenance and repair firm, an insurance firm and a transportation firm.

17. The first vehicle of claim 1, wherein the transceiver receives the first inputs via at least one of a vehicle-to-vehicle (V2V) communication and a vehicle-to-infrastructure (V2I) communication, and wherein the processor is further configured to select a vehicle that provides a higher quality first input, if multiple vehicles provide the first inputs.

18. The first vehicle of claim 1, wherein the processor is further configured to:
cause the transceiver to transmit a monitoring request to a parking assist server to monitor each first vehicle side when the first vehicle approaches a parking lot or is located at the parking lot;
obtain information associated with one or more recommended parking spots in the parking lot from the parking assist server responsive to causing the transceiver to transmit the monitoring request; and
cause the first vehicle to move to a recommended parking spot of the one or more recommended parking spots responsive to obtaining the information associated with the one or more recommended parking spots, wherein the one or more recommended parking spots are associated with parking spots having a high probability of enabling a first vehicle monitoring from each first vehicle side.

19. A vehicle monitoring method comprising:
determining, by a processor, that a predefined condition is met based on inputs obtained from at least one of a first vehicle from a first set of vehicles or a first infrastructure sensor from a first set of infrastructure sensors, wherein the inputs are obtained responsive to transmitting a surveillance request to at least one of the first set of vehicles or the first set of infrastructure sensors located within a first radius from a second vehicle; and
transmitting, by the processor, the surveillance request to at least one of a second set of vehicles or a second set of infrastructure sensors located within a second radius from the second vehicle responsive to determining that the predefined condition is met, wherein the second radius is greater than the first radius.

20. A non-transitory computer-readable storage medium having instructions stored thereupon which, when executed by a processor, cause the processor to:
determine that a predefined condition is met based on inputs obtained from at least one of a first vehicle from a first set of vehicles or a first infrastructure sensor from a first set of infrastructure sensors, wherein the inputs are obtained responsive to transmitting a surveillance request to at least one of the first set of vehicles or the first set of infrastructure sensors located within a first radius from a second vehicle; and
transmit the surveillance request to at least one of a second set of vehicles or a second set of infrastructure sensors located within a second radius from the second vehicle responsive to determining that the predefined condition is met, wherein the second radius is greater than the first radius.
